(19) United States
(12) Patent Application Publication
(10) Pub. No.: US 2016/0062720 A1
(43) Pub. Date: Mar. 3, 2016

(54) DISPLAY DEVICE

(71) Applicant: Chiun Mai Communication Systems, Inc., New Taipei (TW)

(72) Inventor: HOW-WEN CHIEN, New Taipei (TW)

(21) Appl. No.: 14/641,576

(22) Filed: Mar. 9, 2015

(30) Foreign Application Priority Data
Sep. 3, 2014 (CN) 201410444717.5

(51) Int. Cl. G06F 3/14; G02B 3/00

(52) U.S. Cl. CPC G06F 3/1423; G02B 3/005

(57) ABSTRACT

A display device includes an image processor, a display portion, and a lens portion. The image processor processes an image. The display portion includes at least two panels and a gap between the two panels, the panels display the image. The lens portion is coupled to the display portion and faces to a user, and includes a plurality of protruding sections and a plurality of recessing sections formed between adjacent protruding sections, one of the recessing sections is aligned to the gap. The panels emit light to the lens portion, the light is refracted to an area adjacent to the recessing section corresponding to the gap by the lens portion, thus the light renders the gap invisible to the user.

### FIELD

The subject matter herein generally to a display device, and particularly relates to a display device with seamless splicing technology.

### BACKGROUND

Seamless splicing technology is widely used in connecting a plurality of displays together nowadays. However, higher quality and lower cost are needed when designing and manufacturing.

### BRIEF DESCRIPTION OF THE DRAWINGS

Implementations of the present technology will now be described, by way of example only, with reference to the attached figures.

FIG. 1 is a block diagram of an embodiment of a display device.

FIG. 2 is a diagrammatic view of the display device in a state of use.

FIG. 3 is a lens portion of the display device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

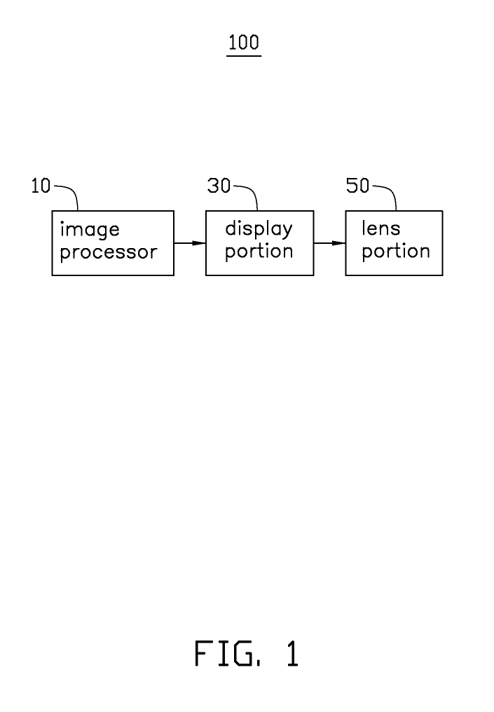

FIGS. 1, 2, and 3 illustrate at least one embodiment of a display device 100. In at least one embodiment, the display device 100 can be a electronic book, a billboard, or a flat panel display, such as a liquid crystal panel, a plasma screen, or an organic electronic optical display, etc. The display device 100 includes an image processor 10, a display portion 20, and a lens portion 30. The image processor 10 is configured to process, such as divide and combine, images to be displayed, and transmit the processed images to the display portion 30. The display portion 30 emits lights to users through the lens portion 50. The display device 100 can further includes a circuit board (not shown), the image processor 10 is mounted on and electrically connected to the circuit board.

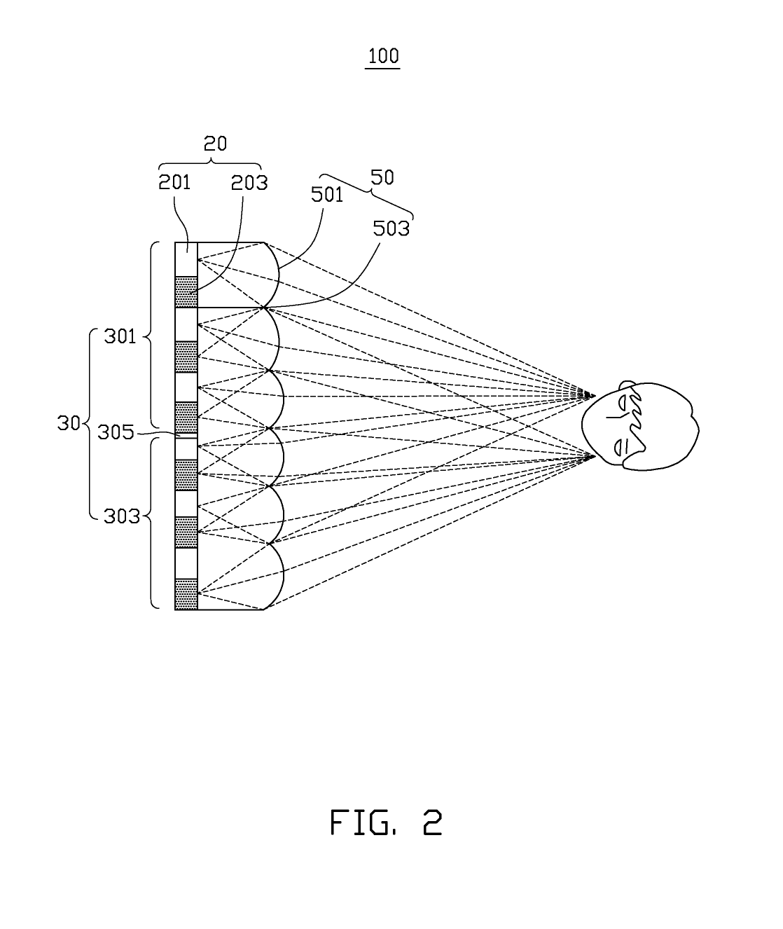

FIG. 2 illustrates that the image processor 10 (not shown) processes the image by time sequence and the processed image includes a plurality of frames 20. Each frame 20 includes a plurality of first units 201 and a plurality of second units 203. The first units 201 and the second units 203 are arranged by turns. A width of each first unit 201 and the second unit 203 is equated to a width of a pixel. In at least one embodiment, the display device 100 has a resolution of 1080p, a.k.a. 1920*1080 pixels. Each frame 20 is vertically divided into a plurality of pictures and the pictures are assigned with a number in order of No. 1, 2, 3, 4, 5, . . . 1919, 1920, wherein the pictures with odd numbers as 1, 3, 5, . . . 1919 are defined as the first units 201; the pictures with even numbers as 2, 4, 6, . . . 1920 are defined as the second units 203. The image processor 10 keeps the pictures 1, 3, 5, . . . 1919 and deletes the pictures 2, 4, 6, . . . 1920, and further copies the pictures 1, 3, 5, . . . 1919 to positions of the pictures 2, 4, 6, . . . 1920. Thus the display device 100 displays pictures 1, 1, 3, 3, 5, 5, . . . 1919, 1919, that is each frame 20 only includes a plurality of the first units 201 and the first units 201 replace the second units 203. In this case, both eyes of the user capture same pictures, but due to widths of the first units 201 and the second units 203 are tiny, thus the frame 20 seems visual continuous by the user.

The display portion 30 includes at least two connected panels and a gap formed between the two connected panels. The at least two connected panels are configured to display a frame 20. In at least one embodiment, the display portion 30 includes a first panel 301, a second panel 303, and a gap 305 formed between the first panel 301 and the second panel 303. The gap 305 extends in a same direction with a division direction of each frame 20, i.e., a vertical direction. The first panel 301 and the second panel 303 cooperatively display the frame 20. The first panel 301 displays a part of the frame 20, which is defined as a first part, the first part includes a plurality of continuous first units 201 and second units 203. The second panel 303 displays the other part of the frame 20, which is defined as a second part, the second part includes a plurality of continuous first units 201 and second units 203. The gap 305 is formed between an edge of the second unit 203 of the first part and an edge of the first unit 201 of the second part. A width of the gap 305 is equated to or less than 2.00 millimeter.

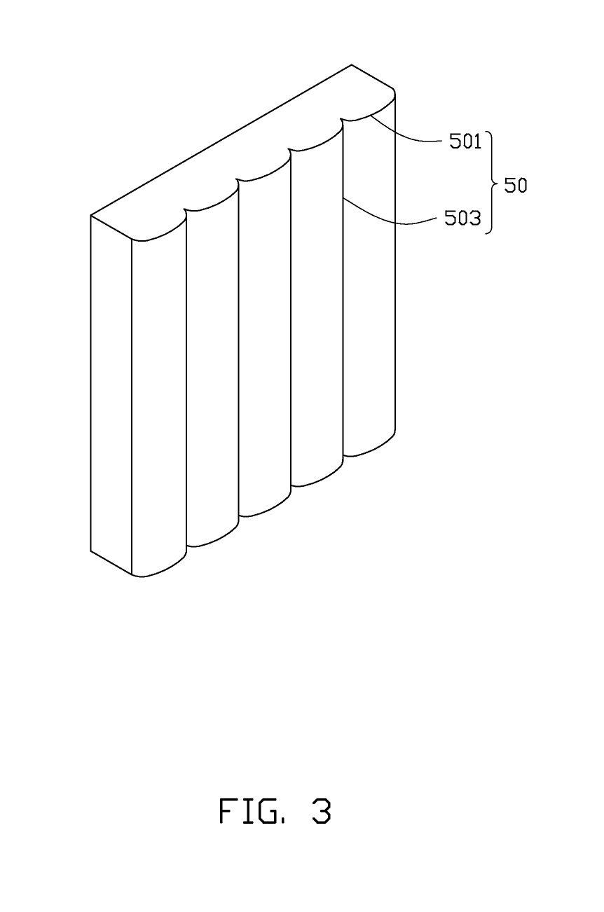

FIGS. 2 and 3 illustrate that the lens portion 50 is coupled to a surface of the display portion 30 faced to the user. A surface of the lens portion 50 opposite to the display portion 30 also faces to the user, the surface is a cylinder lens array, that is optical grating, in at least one embodiment. The lens portion 50 includes a plurality of protruding sections 501 protruding from the surface thereof and a plurality of recessing sections 503 formed between adjacent protruding sections 501. The gap 305 is aligned to one of the recessing sections 503. The plurality of protruding sections 501 are parallel and equidistant to each other, and have a same extending direction with an extending direction of the gap 305. Each protruding section 501 is substantially in semi-cylinder shaped. A total width of one first unit 201 and one second unit 203 is equated to a width of one protruding section 501. A curvature radius and a refractive index of the lens portion 50, a width of each protruding section 501, and a thickness of each recessing section 503 can be adjusted according to the pixel of the display device 100. In at least one embodiment, the width of each protruding section 501 can be 0.01-30 millimeter, the thickness of each recessing section 503 can be 0.01-30 millimeter.

When the display device 100 is in used, the protruding portion 501 faces to the user. The image processor 10 processes images to a plurality of first unit 201 and second unit 203 and transmits to the first panel 301 and the second panel 303. The portion of the first panel 301 and the second panel 303 corresponding to the first unit 201 emits light to the lens portion 50, the light is under refraction by the lens portion 50 and passes through the protruding sections 501 or the recessing sections 503, and then finally reaches a right eye of the user. The portion of the first panel 301 and the second panel 303 corresponding to the second unit 203 emits light to the lens portion 50, the light is under refraction by the lens portion 50 and passes through the protruding sections 501 or the recessing sections 503, and then finally reaches a left eye of the user. Due to each first unit 201 and the corresponding second unit 203 display a same picture, thus the plurality of first units 201 and the corresponding second units 203 display same pictures. Therefore, an image combined by the pictures displayed by the plurality of first units 201 is the same with an image combined by the pictures displayed by the plurality of second units 203, thereby the user can capture a same image by both eyes.

When the gap 305 is aligned to the user, the first unit 201 and the second unit 203 adjacent to the gap 305 emit light and the light is refracted to at a nearby area of the recessing section 503 corresponding to the gap 305. Due to the lens portion 50 being arranged in a cylinder lens array, a small width of the gap 305 and the recessing section 503, the light emitted by the first unit 201 and the second unit 203 adjacent to the gap 305 forms continuous light at the nearby area of the recessing section 503 corresponding to the gap 305. Therefore, the gap 305 is invisible to the user. When the gap 305 is not aligned to the user, the recessing section 503 corresponding to the gap 305 is visually blocked by the protruding sections 501 adjacent thereto, therefore, the gap 305 is invisible by the user. Hence, the gap 305 is covered by the light emitted by the first unit 201 and the second unit 203 and is invisible by the user.

In other embodiments, when the resolution of the display device 100 is fixed, if a size of the first panel 301 and the second panel 303 increases, a width between the two recessing sections 503 increases, a refraction angle of the light increases, a larger width of the gap 305 can be covered.

The display device 100 includes the lens portion 50 in cylinder lens array and the first unit 301 and the second unit 303 emitting light to the pens portion 50 to cover the gap 305. Hence, the first panel 301 and the second panel 303 displays a continuous image without an intermit area caused by the gap 305.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A display device comprising:
an image processor configured to process an image;
a display portion comprising at least two panels and a gap between the two panels, the at least two panels displaying the image transmitted by the image processor; and
a lens portion coupled to the display portion and facing to a user, the lens portion comprising a plurality of protruding sections and a plurality of recessing sections formed between adjacent protruding sections, one of the recessing sections aligned to the gap;
wherein the at least two panels emit light to the lens portion, the light is refracted to an area adjacent to the recessing section corresponding to the gap by the lens portion, thus the light is configured to render the gap invisible to the user.

2. The display device as claimed in claim 1, wherein the image processor processes the image by time sequence to form a plurality of frames, each frame comprises a plurality of first units and a plurality of second units, the first units and the second units are arranged by turns.

3. The display device as claimed in claim 2, wherein the image processor divides the frame into a plurality of first units and second units arranged by turns, and deletes a portion of the frame corresponding to the second units, and then copies another portion of the frame corresponding to the first units to positions of the second units, thus the frame only comprises the portion corresponding to the first unit.

4. The display device as claimed in claim 2, wherein a width of each first unit and the second unit is equated to a width of a pixel of the display device, a total width of one first unit and second unit is equated to a width of one protruding section.

5. The display device as claimed in claim 2, wherein the display device comprises a first panel and a second panel, the first panel and the second panel cooperatively display the frame, the first panel displays a part of the frame, while the second panel displays another part of the frame, the gap is formed between an edge of the second unit of the first part and an edge of the first unit of the second part.

6. The display device as claimed in claim 2, wherein gap extends in a same direction with a division direction of each frame.

7. The display device as claimed in claim 1, wherein a width of each protruding section is 0.01-30 millimeter, a thickness of each recessing section is 0.01-30 millimeter.

8. The display device as claimed in claim 1, wherein a surface of the lens portion is a cylinder lens array, the plurality of protruding sections are parallel and equidistant to each other, and have a same extending direction with an extending direction of the gap.

9. The display device as claimed in claim 1, wherein a width of the gap is equated to or less than 2.00 millimeter.

10. The display device as claimed in claim 1, further comprising a circuit board, wherein the image processor is coupled to the circuit board.

11. A display device comprising:
an image processor configured to process an image into a plurality of first units and second units by turns;
a display portion comprising at least two panels and a gap between the two panels, the at least two panels displaying the image transmitted by the image processor; and
a lens portion coupled to the display portion and facing to a user, the lens portion comprising a plurality of protruding sections and a plurality of recessing sections formed between adjacent protruding sections, one of the recessing sections aligned to the gap;
wherein the first unit and the second unit adjacent to the gap emit light to the lens portion, the light is refracted to an area adjacent to the recessing section corresponding to the gap by the lens portion, thus the light is configured to render the gap invisible to the user.

12. The display device as claimed in claim 11, wherein the image processor processes the image by time sequence to form a plurality of frames, each frame comprises a plurality of first units and a plurality of second units.

13. The display device as claimed in claim 12, wherein the image processor divides the frame into a plurality of first units and second units arranged by turns, and deletes a portion of the frame corresponding to the second units, and then copies another portion of the frame corresponding to the first units to positions of the second units, thus the frame only comprises the portion corresponding to the first unit.

14. The display device as claimed in claim 12, wherein a width of each first unit and the second unit is equated to a width of a pixel of the display device, a total width of one first unit and second unit is equated to a width of one protruding section.

15. The display device as claimed in claim 12, wherein the display device comprises a first panel and a second panel, the first panel and the second panel cooperatively display the frame, the first panel displays a part of the frame, while the second panel displays another part of the frame, the gap is formed between an edge of the second unit of the first part and an edge of the first unit of the second part.

16. The display device as claimed in claim 12, wherein gap extends in a same direction with a division direction of each frame.

17. The display device as claimed in claim 11, wherein a width of each protruding section is 0.01-30 millimeter, a thickness of each recessing section is 0.01-30 millimeter.

18. The display device as claimed in claim 11, wherein a surface of the lens portion is a cylinder lens array, the plurality of protruding sections are parallel and equidistant to each other, and have a same extending direction with an extending direction of the gap.

19. The display device as claimed in claim 11, wherein a width of the gap is equated to or less than 2.00 millimeter.

20. The display device as claimed in claim 11, further comprising a circuit board, wherein the image processor is coupled to the circuit board.
